(19) United States
(12) Patent Application Publication
(10) Pub. No.: US 2005/0146810 A1
(43) Pub. Date: Jul. 7, 2005

(54) Pivot assembly

(75) Inventors: Yasuhiro Mouri, Kitasaku-gun (JP); Toshisada Koyama, Kitasaku-gun (JP)

Correspondence Address: OLIFF & BERRIDGE, PLC, P.O. BOX 19928, ALEXANDRIA, VA, 22320, US

(73) Assignee: MINEBEA CO., LTD., Kitasaku-gun (JP)

(21) Appl. No.: 11/073,843

(22) Filed: Mar. 8, 2005

Related U.S. Application Data
(63) Continuation of application No. 09/902,272, filed on Jul. 11, 2001.

(30) Foreign Application Priority Data
Jul. 17, 2000 (JP) 2000-215807

(51) Int. Cl. G11B 5/55

(52) U.S. Cl. 360/265.6

(57) ABSTRACT

There is provided a pivot assembly for a magnetic disk storage which is improved in its rotating accuracy and reduced in manufacturing cost. A pivot assembly includes a pair of ball bearings each having an outer ring, and the outer ring is fitted directly into an axial bore of an actuator block. This arrangement requires no sleeve to be interposed between the pair of ball bearings and the actuator block, thus enabling to reduce its manufacturing cost. No need to interpose any sleeve allows to increase the thickness of the outer ring of the ball bearing and thus the rigidity thereof, thereby improving the rotating accuracy of the pivot assembly.

### BACKGROUND OF THE INVENTION

1. Field of the Invention

The present invention relates to a pivot assembly for a hard disc drive, more particularly, to a pivot assembly which can be manufactured at an improved cost.

2. Description of Related Art

A hard disk drive (hereafter referred to as HDD) is provided with a pivot assembly which is required to provide a high mechanical accuracy and a low cost. As shown in FIG. 3, the HDD is provided with a pivot assembly 51 which has a pair of ball bearings to support an actuator block 3 of a swing arm. Such conventional pivot assembly 51 comprises a fixed shaft 4, a pair of ball bearing 52 and a sleeve 53. An axial bore 3a of the actuator block 3 is fitted to the outer peripheral surface of the sleeve 53. Also as shown in FIG. 3, the sleeve 53 has, on both sides of an inner peripheral surface thereof, a pair of bearing receptacle 55, each having a bearing holder recess 54 concentric with the sleeve 53 for receiving a corresponding outer ring 52a of the pair of ball bearings 52. It should be noted that the machining precision of the sleeve 53, especially the concentricity between the pair of bearing receptacle 55 and the outer peripheral surface of the sleeve 53, is a critical factor for determining the performance (mechanical accuracy and vibration) of the actuator block 3, namely, a swing arm actuator. Accordingly, the manufacturing of the sleeve is highly delicate issue and requires a high precision machining.

For such conventional pivot assembly 51, the running accuracy of the outer peripheral surface of the sleeve 53 is determined by a composite mechanical precision obtained by adding the precision of a bearing outer ring 52a, and the respective machining precision of the inner peripheral surface and the outer peripheral surface of the sleeve 53. In this context, it is difficult to achieve a high machining precision in terms of concentricity between the pair of bearing receptacles 55 which are machined at both ends of the sleeve 53, and also between the paired receptacles 55 and the outer peripheral surface of the sleeve 53. It means that such machining requires laborious and time consuming processes, thus resulting in a higher manufacturing cost for the pivot assembly 51 as well as requiring additional processes and time to improve the composite precision.

The present invention has been made in view of such drawbacks, and thus it is an object of the present invention to provide an improved pivot assembly for swing arm actuator which can be manufactured at a lower cost with eliminated a sleeve from prior configuration.

### SUMMARY OF THE INVENTION

In accordance with one aspect of the present invention, a pivot assembly for a magnetic disk storage comprises a fixed shaft and a pair of ball bearings mounted thereon to support the actuator block, and the pair of ball bearings are fitted into an axial bore of the actuator block.

With this arrangement, a sleeve conventionally interposed between the pair of ball bearings and the actuator block is no longer necessary, and thus sharply reducing the manufacturing cost for a pivot assembly. With no need of a sleeve, the ball bearing is allowed to have an increased thickness in the radial direction, namely increased to the extent of the thickness of the sleeve, thus enabling to enhance rigidity of the ball bearing.

The present invention also provides a pivot assembly for a magnetic disk storage comprising a fixed shaft and a pair of ball bearings mounted thereon to support an actuator block, characterized in that each of said ball bearings is provided with an outer ring having a thickness increased by the thickness of a sleeve conventionally interposed between a pair of ball bearings and an actuator block, and said pair of ball bearings are fitted directly into an axial bore of said actuator block.

In accordance with another aspect of the present invention, a spacer is interposed between the pair of ball bearings.

Such structure enables to mount a pair of ball bearings in place on the fixed shaft at a predetermined interval therebetween.

In accordance with still another aspect of the present invention, each of the pair of ball bearings has an extension formed on one side of the outer ring, and the pair of ball bearings are mounted onto the fixed shaft with the extensions abutted against each other.

Such structure enables to mount the pair of ball bearings in place on the fixed shaft without using a sleeve or a spacer.

### BRIEF DESCRIPTION OF THE DRAWINGS

FIG. 1 is a sectional view of a pivot assembly according to one embodiment of the present invention;

FIG. 2 is a sectional view of a pivot assembly according to another embodiment of the present invention; and

FIG. 3 is a sectional view of a conventional pivot assembly.

### DETAILED DESCRIPTION OF PREFERRED EMBODIMENTS

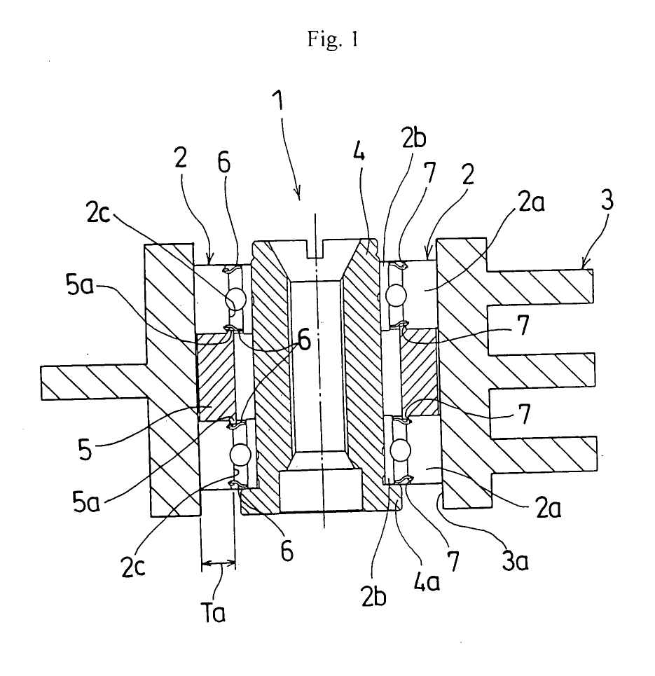

With reference to FIG. 1 of the accompanying drawings, a first embodiment of the present invention will now be described. A pivot assembly according to this embodiment will first be summarized.

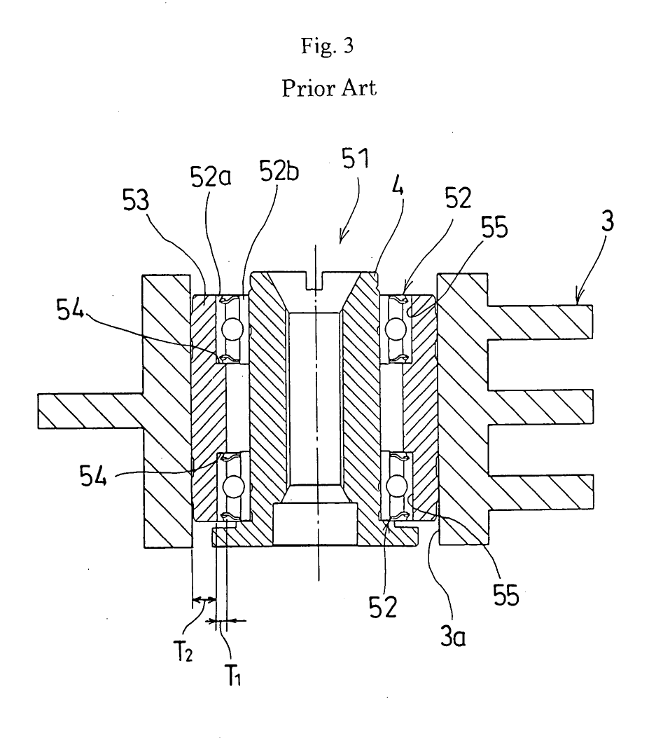

A pivot assembly 1 is provided with a pair of ball bearings 2 each having an outer ring 2a of a thickness (indicated by Ta in FIG. 1) that is thicker than that of the conventional pivot assembly's counterpart, more specifically, thicker by the thickness of a sleeve 53 (T2 in FIG. 3) than the thickness (T1 in FIG. 3) of an outer ring 52a of a ball bearing 52 of a conventional pivot assembly 51. Also the pair of ball bearings 2, at outer ring 2a thereof, directly receive an actuator block 3 of a swing arm. With this arrangement, it is no longer necessary to interpose the sleeve 53 (see FIG. 3) between the actuator block 3 and the pair of ball bearings 52 as was required for the conventional pivot assembly 51, thus sharply reducing a cost for manufacturing the pivot assembly 1. Furthermore, the actuator block 3 is fitted directly onto the ball bearing 2 and the outer ring 2a has an increased thickness which in turn leads to an increased rigidity of the ball bearing 2. Accordingly, a higher precision of swing movement (or concentricity) of the actuator block 3 relative to the pivot assembly 1 is easily achieved and a higher precision of rotating (oscillating) of the swing arm actuator is easily achieved. Alternatively, the increased thickness T2 in FIG. 3 may be distributed among the outer and inner rings 52a and 52b, and the bearing may be manufactured in a larger size corresponding to the increase by thickness T2.

Now the pivot assembly 1 according to the present invention will be described in detail. As shown in FIG. 1, the pivot assembly 1 includes a fixed shaft 4 stood on a base plate of a magnetic disk storage (not shown), a pair of ball bearings 2 disposed on the fixed shaft 4, and an annular spacer 5 interposed between the pair of ball bearings 2. Each of the ball bearings 2 has an annular groove 7 on the inner peripheral surface 2c of the outer ring 2a at both edges. The annular groove 7 is provided with a seal or shield 6 for preventing a leakage of grease sealed into a space between the outer ring 2a and the inner rings 2b and for preventing a foreign material from entering a rolling contact surface of the bearings. The spacer 5 has annular projections 5a on inner surface of both sides thereof, each protruding in the thickness direction of the spacer 5 and engaging with each of the opposing annular grooves 7 on the pair of ball bearings 2. The spacer 5 is formed in such a size that its outside diameter is slightly smaller than the outside diameter of the ball bearing 2. One side of the inner ring 2b of the ball bearing 2 located on the lower side is abutted against a flange 4a of the fixed shaft 4 in such a manner as to set the pair of ball bearings 2 in position in the axial direction of the fixed shaft 4. Then, the actuator block 3 is mounted onto the fixed shaft by fitting the ball bearings 2 into an axial bore 3a of the actuator block 3, thereby making the pivot assembly 1 support the actuator block 3.

With this arrangement, the pivot assembly 1 according to the present invention is provided with the pair of ball bearings 2 in which the outer ring 2a has a thickness (Ta in FIG. 1) is thicker by the thickness (T2 in FIG. 3) of the sleeve 53 than the thickness (T1 in FIG. 3) of the outer ring 52a of the ball bearing 52 of the conventional pivot assembly 53, and the actuator block 3 of the HDD is directly fitted on to the outer ring 2a of the pair of ball bearings 2. As a result, the pivot assembly 1 no longer needs to provide such sleeve 53 (see FIG. 3) used for the conventional pivot assembly 51, thereby allowing to sharply reduce the manufacturing cost for the pivot assembly 1.

In addition, elimination of the sleeve 53 interposed between the actuator block 3 and the ball bearings 2 solves problems regarding the fitting precision between the sleeve 53 and the outer ring 2a of the ball bearing 2 and wearness of a contact surface of those parts. Furthermore, the ball bearings are provided with such increased thickness of the outer ring 2a of the pair of ball bearings 2 while the spacer 5 has the annular projection 5a engaging with the opposing annular grooves 7 provided on one side of the outer ring 2a of the respective ball bearings 2, and thereby keeping the bearings in alignment with each other, and thus achieving a proper rigidity of the pivot assembly 1. Therefore, the swing precision (concentricity) between the actuator block 3 and the pivot assembly 1 is achieved with less difficulty, and the rotating (oscillating) accuracy for the swing arm actuator (not shown) is improved.

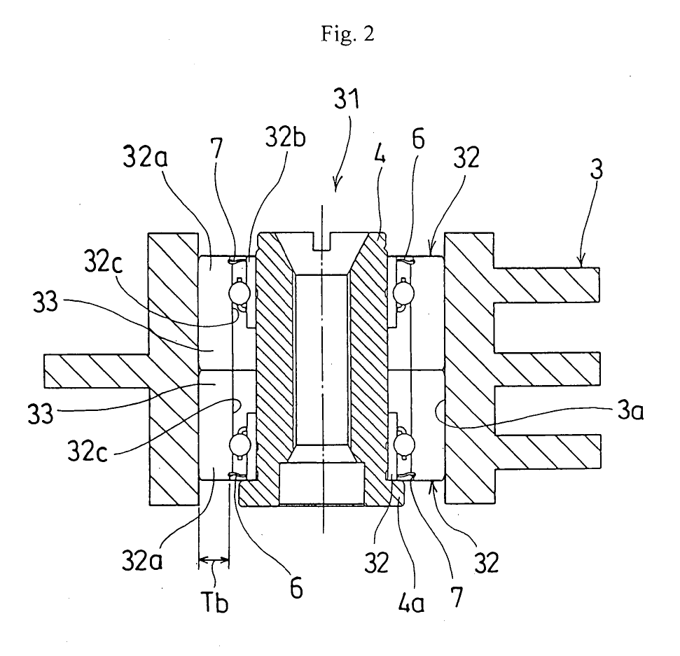

Now a pivot assembly according to another embodiment of the present invention will be described with reference to FIG. 2. Wherever possible, the same reference numerals will be used throughout the drawings to refer to parts which are the same in structure of those in the above-described pivot assembly 1 in FIG. 1. A pivot assembly 31 according to this second embodiment will be first summarized.

The pivot assembly 31 is provided with a pair of ball bearings 32 each having an outer ring 32a of a thickness (indicated by Tb in FIG. 2) that is larger than that of a conventional pivot assembly's counterpart, more specifically, larger by the thickness of the sleeve 53 (T2 in FIG. 3) than the thickness (T1 in FIG. 3) of an outer ring 52a of the ball bearing 52 of the conventional pivot assembly 53. The pair of ball bearings 32, at outer rings 32a thereof, directly receive the actuator block 3 of the swing arm actuator. Further, as shown in FIG. 2, an extension 33 is extending from one side of each outer ring 32a of the pair of ball bearings 32 in such manner that the pair of ball bearings 32 have the respective extensions 33 abutted against each other when the ball bearings are mounted on to the fixed shaft 4. With this arrangement, it is no longer necessary to provide the sleeve 53 (see FIG. 3) that was required for the conventional pivot assembly 51, nor the spacer 5 (see FIG. 1) for the pivot assembly 1 described hereinabove.

In addition, the number of shields 6 and hence of annular grooves 7 for receiving the same is reduced, thus simplifying the structure of the pivot assembly 31 and therefore resulting in a sharply reduced cost for manufacturing the pivot assembly 31. Furthermore, the actuator block 3 is fitted directly onto the ball bearing 32 and the outer ring 32a has an increased thickness which in turn leads to an increased rigidity of the ball bearing 32. Accordingly, a higher precision of swing movement (or concentricity) of the actuator block 3 relative to the pivot assembly 31 is easily achieved and a higher rotating (oscillating) accuracy for the swing arm actuator is achieved.

Now the pivot assembly 31 according to the present embodiment will be described in detail. As shown in FIG. 2, the pivot assembly 31 includes the fixed shaft 4 stood on a base plate of a magnetic disk storage (not shown), and a pair of ball bearings 32 disposed on the fixed shaft 4. Each of the ball bearings 32 has an annular groove 7 on one side edge of an inner peripheral surface 32c of the outer ring 32a, and a seal or shield 6 for preventing a leakage of grease sealed into the ball bearing and preventing a foreign material from entering a rolling contact surface of the bearings. As shown in FIG. 2, on another side of the respective outer rings 32a of the pair of ball bearings 32, an extension 33 extending in the axial direction is formed. The extensions 33 of the pair of ball bearings 32 are abutted against each other. The ball bearing 32 located on the lower side has its inner ring 32b abutted against a flange 4a of the fixed shaft 4 in such a manner as to set the pair of ball bearings 32 in position in the axial direction of the fixed shaft 4. Then the ball bearings 32 are fitted into an axial bore 3a of the actuator block 3 to thereby make the pivot assembly 31 support the actuator block 3.

With this arrangement, the pivot assembly 31 according to the present embodiment is provided with the pair of ball bearings 32 in which the outer ring 32a has a thickness (Tb in FIG. 2) is thicker by the thickness (T2 in FIG. 3) of the sleeve 53 than the thickness (T1 in FIG. 3) of the outer ring 52a of the ball bearing 52 of the conventional pivot assembly 53, and the actuator block 3 of the swing arm actuator is directly fitted onto the outer ring 32a of the pair of ball bearings 32. Also the pair of ball bearings 32 are provided with the extension 33 extending from one side of the outer ring 32a so that the extensions 33 of the pair of ball bearings 32 are abutted against each other when mounted in the pivot assembly 31. As a result, the proposed pivot assembly no longer needs to be provided with the sleeve 53 (see FIG. 3) used for the conventional pivot assembly 51, nor the spacer 5 (see FIG. 1) used in the pivot assembly 1. Furthermore, such arrangement structure makes possible to reduce the number of shields 6 and annular grooves 7 for mounting the same, thereby simplifying the structure of the pivot assembly 31 and thus allowing to sharply reduce the manufacturing cost for the pivot assembly 31.

Furthermore, the actuator block 3 is fitted directly onto the ball bearings 32, and the ball bearings 32 are provided with such increased thickness of the outer ring 32a with, and thus achieving an increased rigidity of the same. Therefore high swing precision (concentricity) between the actuator block 3 and the pivot assembly 31 is achieved with less difficulty, and the rotating (oscillating) accuracy for the pivot assembly 31, that is, the swing arm actuator is improved.

According to one aspect of the present invention, the pivot assembly has the outer rings of the pair of ball bearings fitted directly into the axial bore of the actuator block, thereby making it unnecessary to interpose a sleeve between the pair of ball bearings and the actuator block in the conventional pivot assembly. As a result, the manufacturing cost for the pivot assembly can be sharply reduced.

In addition, elimination of the sleeve to be interposed between the actuator block and the ball bearings solves problems regarding the fitting precision between the sleeve and the outer ring of the ball bearing and wearness of a contact surface of those parts. Furthermore, the ball bearings are provided with such outer rings having a thickness increased by the thickness of the sleeve, and thus achieving a higher rigidity of the ball bearings. The increased thickness of the outer ring prevents undesired deformation thereof often caused while mounting the actuator block onto the same through press-fitting. Therefore, the swing precision (concentricity) between the actuator block and the pivot assembly is achieved with less difficulty, and the rotating (oscillating) accuracy for the swing arm actuator can be improved.

According to another aspect of the present invention, a spacer is interposed between the pair of ball bearings and the spacer has annular projections engaged with each of the opposing annular grooves provided on one side of the outer ring of the pair of ball bearings. Consequently, the bearings are kept in alignment, and thus achieving a high rigidity of the pivot assembly with no need to provide the sleeve. Therefore, improved swing precision of the pivot assembly is achieved for improving the rotating accuracy for the swing arm actuator while achieving reduced manufacturing cost.

According to still another aspect of the present invention, each of the pair of ball bearings has an extension extending from one side of the outer ring, and the extensions are abutted against each other when the pair of ball bearings are mounted onto the fixed shaft. As a result, the proposed pivot assembly no longer needs to be provided with the sleeve nor the spacer, thereby simplifying the structure of the pivot assembly and thus allowing to sharply reduce the manufacturing cost for the pivot assembly.

1. A pivot assembly for a magnetic disk storage comprising:
an actuator block having an axial bore;
a fixed shaft;
a pair of ball bearings mounted thereon to support the actuator block, each of the pair of ball bearings having:
an outer ring having outer and inner peripheral surfaces, the inner peripheral surface having an annular groove at each edge,
an inner ring that directly engages the fixed shaft, and
a pair of shields engaging the outer and inner rings, each shield disposed within the annular groove at said each edge; and
an annular spacer disposed between the pair of ball bearings, the annular spacer having an inner axially-extending annular projection and an outer end face, the annular projection having an outer rim surface, wherein the pair of ball bearings is fitted directly into the axial bore of the actuator block, the outer peripheral surface of the outer ring directly engages the actuator block, the outer end face is adjacent to the outer peripheral surface of the outer ring, and the outer rim surface of the annular projection is adjacent to the inner peripheral surface of the outer ring.

2. A pivot assembly for a magnetic disk storage comprising:
an actuator block having an axial bore;
a fixed shaft;
a pair of ball bearings mounted thereon to support the actuator block, each of the pair of ball bearings having:
an outer ring having outer and inner peripheral surfaces, the inner peripheral surface having an annular groove at each edge,
an inner ring that directly engages the fixed shaft, and
a pair of shields engaging the outer and inner rings, each shield disposed within the annular groove at said each edge; and
an annular spacer disposed between the pair of ball bearings, the annular spacer having an inner axially-extending annular projection, the annular projection having an outer rim surface, wherein each of the outer rings has an outer ring thickness increased by a sleeve thickness of a sleeve conventionally interposed between the pair of ball bearings and the actuator block, and the pair of ball bearings is fitted directly into the axial bore of the actuator block, the outer peripheral surface of the outer ring directly engages the actuator block, the outer end face is adjacent to the outer peripheral surface of the outer ring, and the outer rim surface of the annular projection is adjacent to the inner peripheral surface of the outer ring.

3. The pivot assembly according to claim 1, wherein the annular projection engages the shield.

4. A pivot assembly for a magnetic disk storage comprising:
an actuator block having an axial bore;
a fixed shaft;
a pair of ball bearings mounted thereon to support the actuator block, each of the pair of ball bearings having:
an outer ring having outer and inner peripheral surfaces, the inner peripheral surface having an annular groove at an outer edge of the pair of ball bearings,
an inner ring that directly engages the fixed shaft, and
a shield engaging the outer and inner rings and disposed within the annular groove; and
a pair of annular extensions disposed on the outer peripheral surface of the outer ring of said each of the pair of ball bearings, wherein said pair of ball bearings and the pair of annular extensions are fitted into the axial bore of the actuator block, and said pair of ball bearings are mounted onto said fixed shaft with said extensions abutted against each other.

5. The pivot assembly according to claim 2, wherein the annular projection engages the shield.
